(19) United States
(12) Patent Application Publication
(10) Pub. No.: US 2004/0135357 A1
(43) Pub. Date: Jul. 15, 2004

(54) Vehicle body of electric vehicle

(76) Inventor: Ferretti Chang, Taipei (TW)

Correspondence Address: Ferretti Chang, P.O. Box No. 6-57, Chung-Ho, Taipei, 235, TW

(21) Appl. No.: 10/339,330

(22) Filed: Jan. 10, 2003

(51) Int. Cl. B62D 21/00

(52) U.S. Cl. 280/781

(57) ABSTRACT

The vehicle body for electric vehicle includes a loading frame for holding a seat, and a body frame for disposing operating assemblies namely driving wheels and a motor. Wherein, the driving wheels and the motor are disposed and upheld at the front of the body frame also provided with secondary wheels. At the rear of the body frame is pivotally connected with the rear of the loading frame by means of extended vertical posts, and a combined shock absorber is also provided at the front of the body frame and the loading frame. Guiding wheels capable of floating up and down are further provided at the front of the body frame.

### BACKGROUND OF THE INVENTION

(a) Field of the Invention

The invention relates to a vehicle body of electric vehicle that provides better safety when driving. A stabilizing force for staying close to the ground is generated between the driving wheels and secondary wheels thereof by a floating effect of the guiding wheels thereof. A shock absorber between the loading frame and the body frame thereof is adjustable for coordinating with the center of gravity changes occurred during tilting of the vehicle body to further stabilize the center of gravity of the upper and lower parts of the vehicle body, thereby increasing the safety thereof when driving.

(b) Description of the Related Art

A common electric vehicle is consisted of a vehicle for holding a seat, driving wheels, a motor, and secondary wheels, such that the user is able to sit on the seat of the vehicle frame and is transported by impelling and rotating the driving wheels through the motor. In a prior vehicle body, only the driving wheels and the secondary wheels are in contact with the ground for developing a mechanism that stabilizes the center of gravity of the vehicle body, and therefore, because of the fixed distance between the seat, the driving wheels and the secondary wheels, the vehicle body is prone to turnovers due to the center of gravity tilted in the lack of adaptive functions for different landforms when encountering inclined surfaces or surfaces having different heights.

Soon after that, a vehicle body formed by pivotally disposing of a body frame provided with driving wheels and secondary wheels to another body frame provided with a seat and accompanying guiding wheels has become available, in which the seat is capable of making appropriate adjustments with the driving wheels and secondary wheels in coordination with a force of the guiding wheels for staying close to the ground, thereby achieving a stable driving on the ground with adaptations to different landforms.

However, in the above design, appropriate adjustments take place between the seat and the frames of the driving wheels and secondary wheels by having the guiding wheels stay close to the ground. The seat thereof yet tilts forward as a result of adapting to landforms, and therefore the passenger is even more liable to accidents such as falling off the seat when the seat tilts suddenly.

In addition, seat assemblies in a prior electric vehicle mostly target at combination effect with vehicle body thereof, and seat assemblies are completed by fastening using screw bolts. The screw bolts may loosen and eve n come off consequent on vibrations after driving for a period of time, thus increasing the chances of accidents. Also, complicated dismantling of the vehicle body assemblies has to be performed in order to remove the seat from a vehicle body, hence further causing maintenance inconveniences of the electric vehicle.

### SUMMARY OF THE INVENTION

The vehicle body of electric vehicle according to the invention comprises a rigid vehicle body formed by pivotally connecting a loading frame for holding a seat, and a body frame for disposing operating assemblies including driving wheels and a motor. Wherein, the driving wheels and the motor are disposed and upheld at the front of the body frame also provided with secondary wheels at the rear thereof. The rear of the body frame is further provided with vertical posts extended upward for pivotally fastening to the rear of the loading frame. At the front of the loading frame and the body frame is combined with a shock absorber, and at the front of the body frame is supplied with guiding wheels capable of floating up and down. During progression of the vehicle body, a stabilizing force is generated between the driving wheels and the secondary wheels for staying close to the ground by the floating effect of the guiding wheels. In addition, the shock absorber between the loading frame and the body frame contracts and expands according to the center of gravity changes of the vehicle body when the vehicle body is tilted forward and backward, thereby stabilizing center of gravity at the upper and lower parts of the vehicle body for further increasing the safety when driving.

Furthermore, at the two rear sides of the loading frame for fitting a seat is provided with an accommodating member transversely disposed with an accommodating opening, respectively. At the front of the loading frame for fitting the seat is provided with a positioning member further perpendicularly disposed with a positioning orifice. On a frame body of the seat assembled with the loading frame is provided with transverse inserting poles that extend backward at positions corresponding to the accommodating member and the positioning member, and a perpendicular stop twig. The inserting poles at the frame body of the seat are then transversely inserted into the accommodating orifice of the accommodating member, and the stop twig is pressed into the positioning orifice at the positioning member for prohibiting the inserting poles breaking off from the accommodating member while also achieving a rigid combination of the seat and the vehicle body by inserting and fastening the inserting poles into the accommodating member.

### BRIEF DESCRIPTION OF THE DRAWINGS

FIG. 1 is a schematic view of the appearance of the structure in accordance with the invention.

FIG. 2 is an exploded view of the structure in accordance with the invention.

FIG. 3 is a side view of the structure in accordance with the invention.

FIG. 4 is a structural schematic view of the front guiding wheels and the motor disposed and upheld in accordance with the invention.

FIG. 5 is a structural schematic view of the upheld pedal in accordance with the invention.

FIG. 6 is an exploded structural view of the seat and loading frame in accordance with the invention.

FIG. 7 is a sectional view of the inserting poles inserted into the accommodating members in accordance with the invention.

FIG. 8 is a sectional view of the stop twig inserted into the positioning members in accordance with the invention.

### DESCRIPTION OF THE PREFERRED EMBODIMENTS

To better understand the structure and operating principle of the invention, illustrations shall be given hereunder with the accompanying drawings.

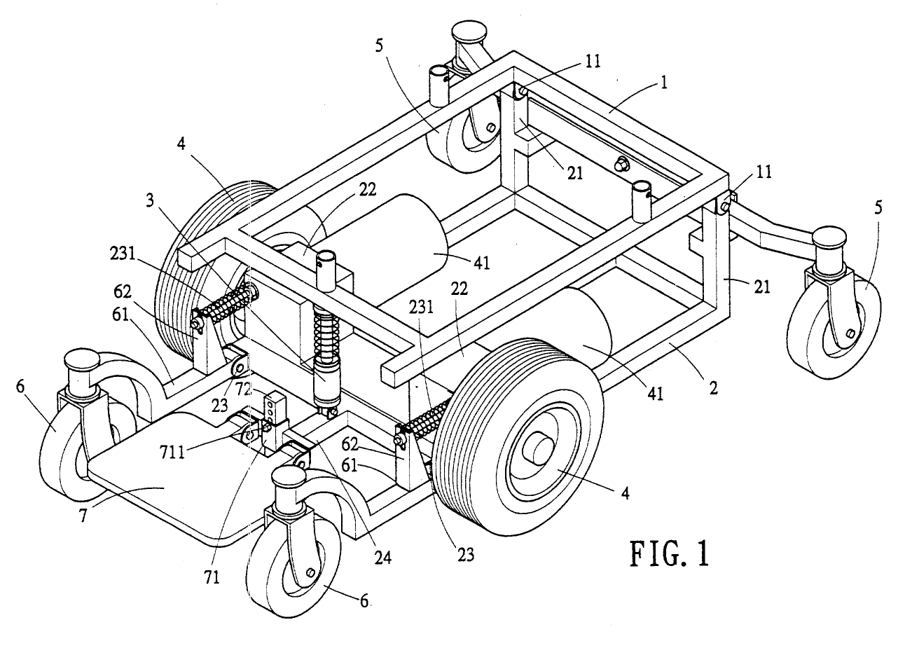

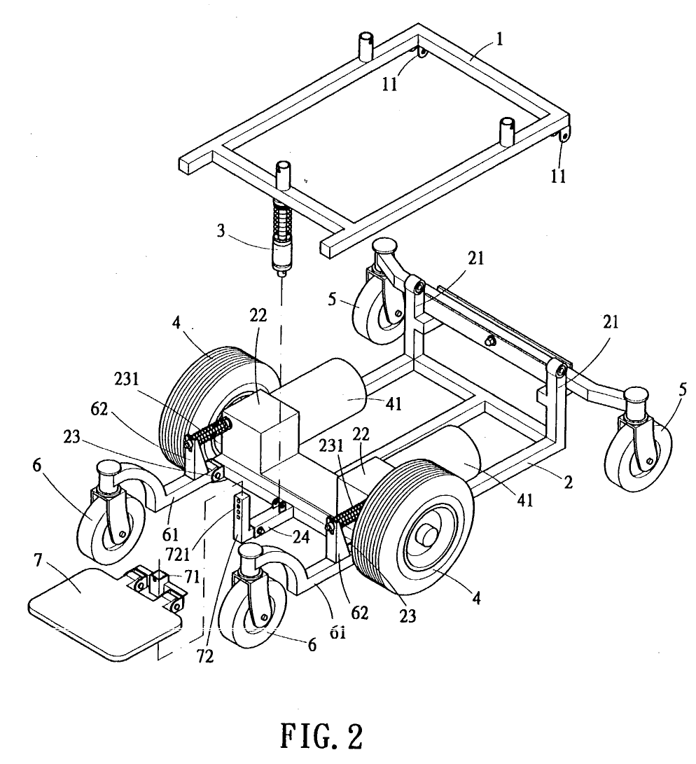

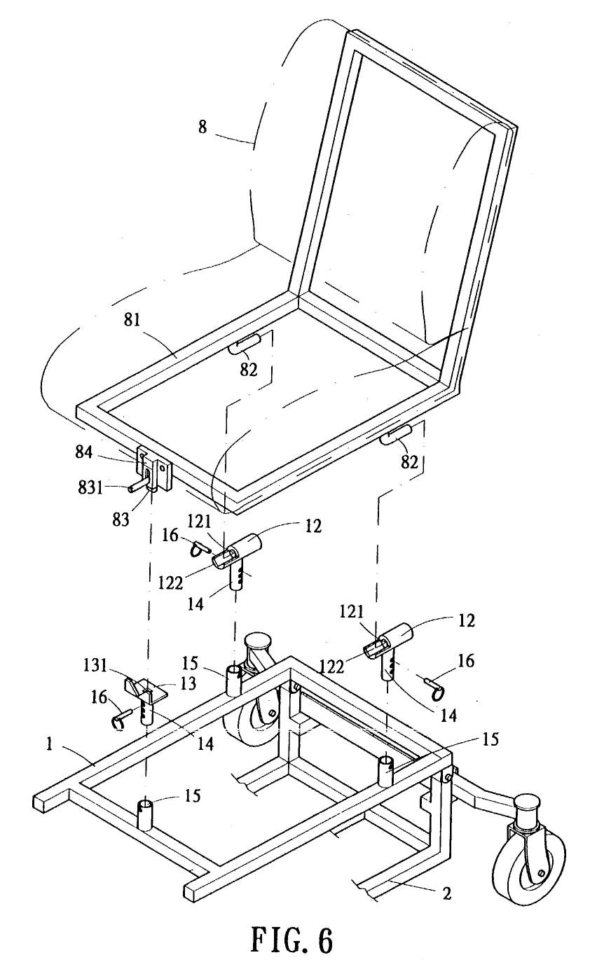

Referring to FIGS. 1 and 6 showing the fundamental structure of the vehicle body for electric vehicle in accordance with the invention, the vehicle body comprises a loading frame 1 for holding a seat 8, and a vehicle frame 2 for disposing operating assemblies including driving wheels 4 and a motor 41. Referring to FIGS. 1 and 2, wherein the driving wheels 4 and the motor 41 are disposed and upheld at the front of the vehicle frame 2 also provided with secondary wheels 5 at the rear thereof. The rear of the body frame 2 is further provided with vertical posts 21 extended upward for pivotally fastening to the rear of the loading frame 1. At the front of the loading frame 1 and the body frame 2 is combined with a shock absorber 3, and at the front of the body frame 2 is supplied with guiding wheels 6 capable of floating up and down. During progression of the vehicle body, a stabilizing force is generated between the driving wheels 4 and the secondary wheels 5 for staying close to the ground by the floating effect of the guiding wheels 6. In addition, the shock absorber 3 between the loading frame 2 and the body frame 1 contracts and expands according to the center of gravity changes of the vehicle body when the vehicle body is tilted forward and backward, thereby stabilizing center of gravity at the upper and lower parts of the vehicle body for further increasing the safety when driving.

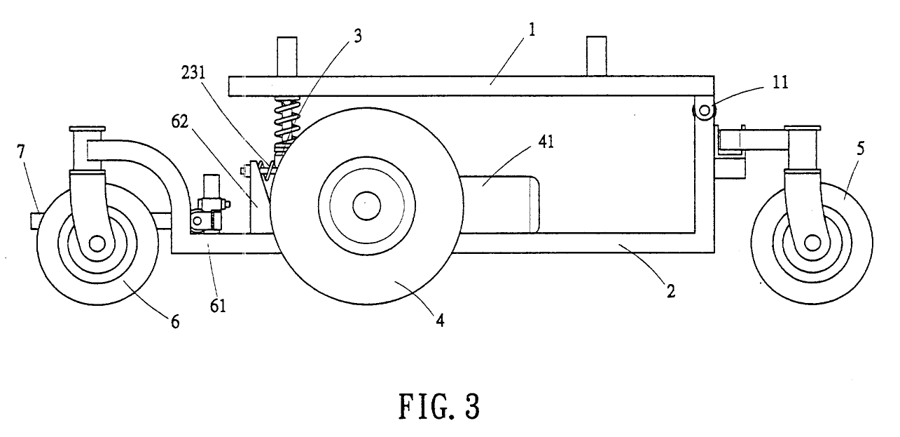

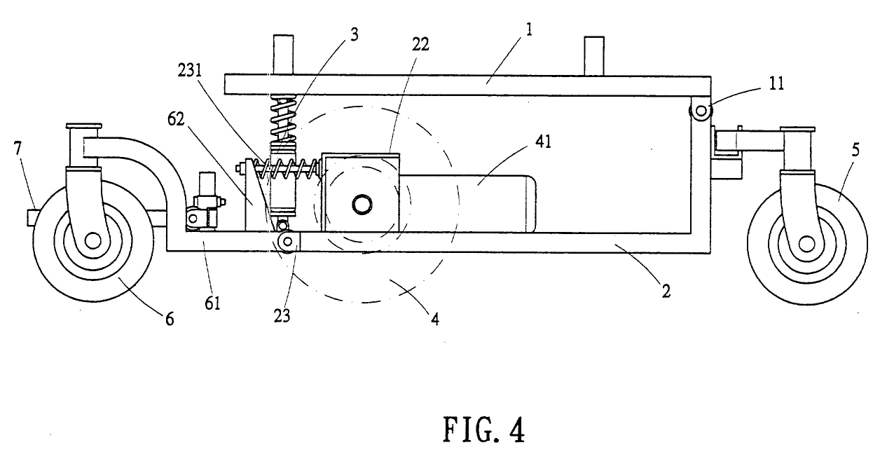

Referring to FIGS. 2 and 3, wherein the loading frame 1 and the body frame 2 are a structure of a square frame offering the vehicle body with optimal strength. Also, at corresponding positions of the loading frame 1 and the body frame 2 are provided with body frame pivotal members 11 for pivotally fastening the loading frame 1 to the body frame 2. Referring to FIG. 4, the front rim of the body frame 2 is similarly provided with guiding wheel pivotal members 23 such that the guiding wheels 6 are pivotally fastened by the guiding wheel pivotal members 23 at the front rim of the body frame 2 along with transversely disposed extension arms 61. In addition, restoring springs 231 are transversely provided at the upper part of corresponding guiding wheel pivotal members 23 as extensions thereto. Vertical block members 62 provided are also extended upward from the extension arms 61 for holding the restoring springs 231, so that apart from the floating effect of the guiding wheels 6, the body frame 2 is able to maintain at a horizontal plane through the reactions of the restoring springs 231, thereby avoiding sudden tilts of the vehicle body and increasing the stability during riding for passengers.

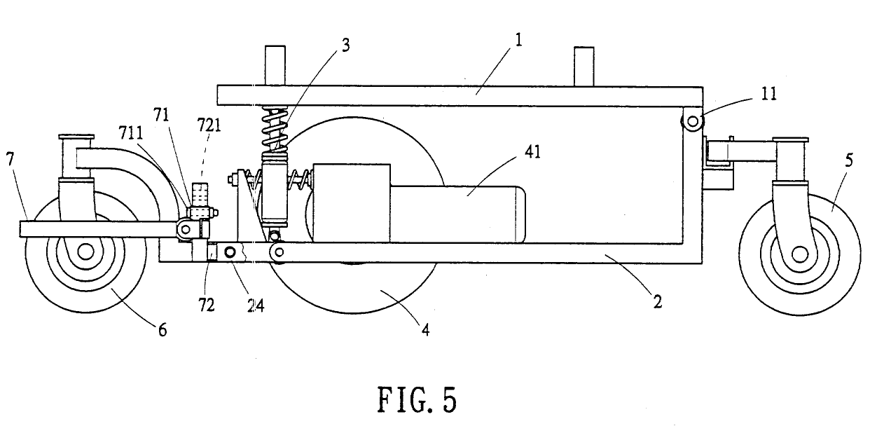

In addition, referring to FIGS. 1 and 4, at the two front sides of the body frame 2 are fixed with two motor frames 22 for firmly fixing the motor 41 and the vehicle body, thus reinforcing the rigidity of the vehicle body structure. Referring to FIG. 5, an extended accommodating member 24 is provided at the center of the front of the body frame 2 for pivotally disposing a pedal 7 in coordination with a first accommodating member 71, and then an L-shaped accommodating shaft 72 is used for connecting the first accommodating member 71 to the extended accommodating member 24, wherein the L-shaped accommodating shaft 72 is distributed with positioning orifices 721 having appropriate distances in between so that securing bolts 711 are penetrated through the positioning orifices 721 for connecting the first accommodating member 71 to the extended accommodating member 24. Also, the contraction between the L-shaped accommodating shaft 72 and the extended accommodating member 24 is used for adjusting the front and rear distances of the pedal 7, and the vertical positions of the first accommodating member 71 at the L-shaped accommodating shaft 72 are also employed for regulating the height of the pedal 7, thus significantly enhancing the practical values of the vehicle body.

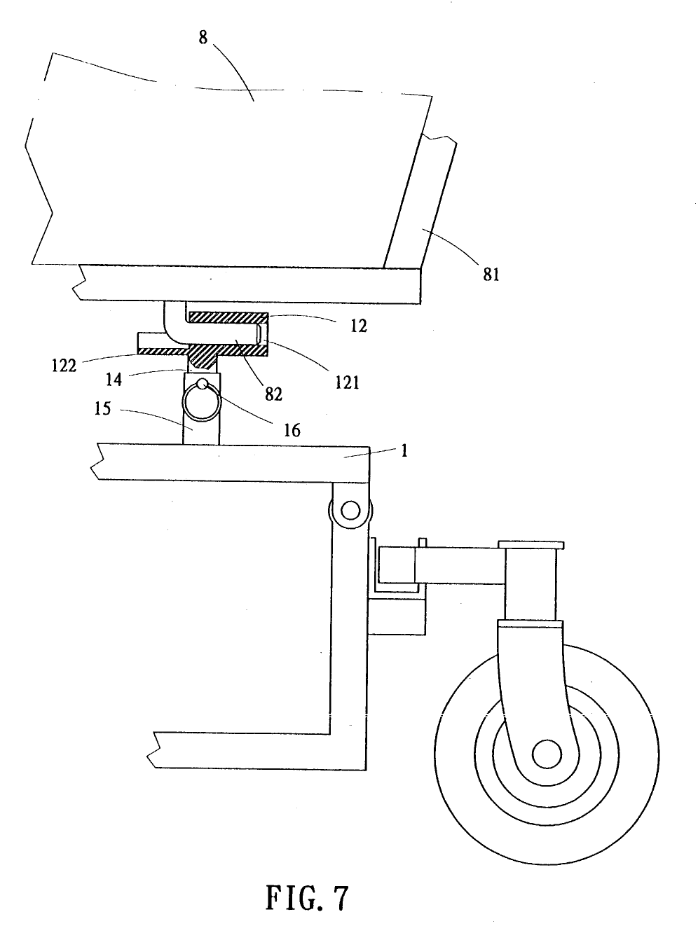

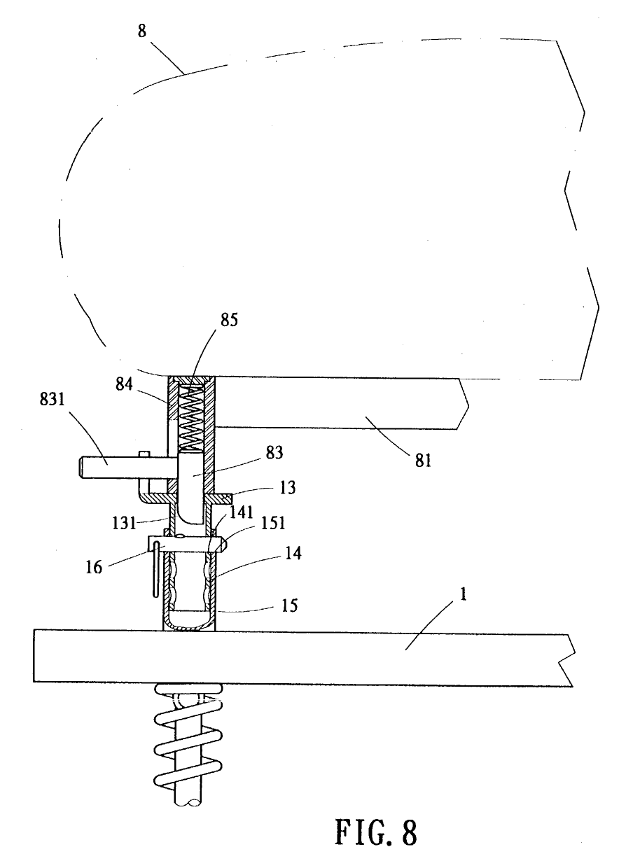

Moreover, referring to FIGS. 6 to 8, at the two rear sides of the loading frame 1 for fitting a seat 8 is provided with a second accommodating member 12, respectively, further transversely disposed with an accommodating opening 121, respectively. At the front of the loading frame 1 for fitting the seat 8 is provided with a positioning member 13 further perpendicularly disposed with a positioning orifice 131. On a frame body 81 of the seat 8 assembled with the loading frame 1 is provided with transverse inserting poles 82 that extend backward at positions corresponding to the accommodating members 12 and the positioning member 13, and a perpendicular stop twig 83. The inserting poles 82 at the frame body 81 of the seat 8 are then transversely inserted into the accommodating orifices 121 of the second accommodating members 12, and the stop twig 83 is pressed into the positioning orifice 131 at the positioning member 13 for prohibiting the inserting poles 82 breaking off from the accommodating member 12, while also achieving a rigid combination of the seat 8 and the vehicle body by inserting and fastening the inserting poles 82 into the accommodating members 12.

Furthermore, a supporting segment 122 is formed at the front rim of the second accommodating members 12, respectively. The stop twig 83 is placed within a casing 84 at the front rim of the frame body 81 of the seat 8, and is also provided with a restoring spring 85 for pushing the stop twig 83 against the positioning member 13. On the main body of the stop twig 83 is additionally disposed with a trigger post 831 capable of localizing the stop twig 83 and the inserting pole 82 of the seat 8 onto the positioning member 13 of the main body and the supporting segment 122 of the second accommodating members 12. The seat 8 is thereupon moved toward the direction of inserting pole 82 inserting into the accommodating orifice 121 such that the inserting pole 82 is fitted into the orifice 121 and the stop twig 83 is placed into the positioning orifice 131 at the positioning member 13, thereby readily completing the assembly of the seat 8 and the vehicle body. Vice versa, when removing the seat 8 from the vehicle body, the trigger post 831 is triggered for separating the stop twig 83 from the positioning orifice 131 at the positioning member 13. The seat 8 is then dismantled by moving the inserting pole 82 toward the direction of withdrawal of the second accommodating members 12. The seat 8 is removed from the vehicle body as a result for further maintenance of the electric vehicle.

Besides the above, at the bottom of the second accommodating members 12 and the positioning member 13 are provided with a vertical accommodating pole 14, respectively, and on the loading frame 1 is disposed with accommodating pipes 15 for accommodating corresponding vertical accommodating poles 14. The vertical accommodating poles 14 and the accommodating pipes 15 are further provided with positioning orifices 141 and 151, respectively for inserting twigs 16 to insert and fasten therein, thus inserting and fastening the vertical accommodating poles 14 into the accommodating pipes 15. The relative positions of the accommodating poles 14 and the accommodating pipes 15 may also be altered for changing the heights of the second accommodating members 12 and the positioning member 13, thereby adjusting the height of the seat 8.

In the vehicle body of electric vehicle in accordance with the invention, the rear of the body frame thereof is pivotally connected with the rear of the loading frame thereof by means of extended vertical posts. A combined shock absorber is also provided at the front of the body frame and the loading frame, and guiding wheels capable of floating up and down are further provided at the front of the body frame, such that a stabilizing force is generated between the driving wheels and the secondary wheels thereof by the floating effect of the guiding wheels. In addition, the shock absorber contracts and expands according to the center of gravity changes of the vehicle body when the vehicle body is tilted forward and backward, thereby stabilizing center of gravity at the upper and lower parts of the vehicle body for further increasing the safety when driving. It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A vehicle body of electric vehicle comprising a loading frame for holding a seat, and a body frame for disposing operating assemblies including driving wheels and a motor; wherein, the driving wheels and the motor are disposed and upheld at the front of the body frame also provided with secondary wheels at the rear thereof; and the characteristics thereof are:
the rear of the body frame is pivotally connected with the rear of the loading frame by means of extended vertical posts; a combined shock absorber is also provided at the front of the body frame and the loading frame, and guiding wheels capable of floating up and down are further provided at the front of the body frame, such that a stabilizing force is generated between the driving wheels and the secondary wheels thereof by the floating effect of the guiding wheels; as a result, the shock absorber contracts and expands according to the center of gravity changes of the vehicle body when the vehicle body is tilted forward and backward, thereby stabilizing center of gravity at the upper and lower parts of the vehicle body for further increasing the safety when driving.

2. The vehicle body of electric vehicle according to claim 1, wherein at the two side of the front of the body frame are fixed with motor frames for firmly fixing the motor to the vehicle body, thus reinforcing the rigidity of the vehicle body structure.

3. The vehicle body of electric vehicle according to claim 1, wherein the loading frame and the body frame are a structure of a square frame offering the vehicle body with optimal strength; at corresponding positions of the loading frame and the body frame are provided with body frame pivotal members for pivotally fastening the loading frame to the body frame; at the front rim of the body frame is provided with guiding wheel pivotal members such that the guiding wheels are pivotally fastened by the guiding wheel pivotal members at the front rim of the body frame along with transversely disposed extension arms; restoring springs are transversely provided at the upper part of corresponding guiding wheel pivotal members as an extension thereto, and vertical block members extended upward are also provided for holding the restoring springs; as a result, apart from the floating effect of the guiding wheels, the body frame is able to maintain at a horizontal plane through the reactions of the restoring springs, thereby avoiding sudden tilts of the vehicle body and increasing the stability of riding for passengers.

4. The vehicle body of electric vehicle according to claim 1, wherein an extended accommodating member is provided at the center of the front of the body frame for pivotally disposing a pedal in coordination with a first accommodating member; an L-shaped accommodating shaft is used or connecting the first accommodating member to the extended accommodating member and is distributed with positioning orifices with appropriate distances in between so that securing bolts are penetrated through the positioning orifices for connecting the first accommodating member to the extended accommodating member; and the contraction between the L-shaped accommodating shaft and the extended accommodating member is used for adjusting the front and rear distances of the pedal, and the vertical positions of the first accommodating member at the L-shaped accommodating shaft are also employed for regulating the height of the pedal, thus significantly enhancing the practical values of the vehicle body.

5. The vehicle body of electric vehicle according to claim 1 wherein at the two rear sides of the loading frame for fitting a seat is provided with a second accommodating member further transversely disposed with an accommodating opening, respectively; at the front of the loading frame for fitting the seat is provided with a positioning member further perpendicularly disposed with a positioning orifice; on a frame body of the seat assembled with the loading frame is provided with transverse inserting poles that extend backward at positions corresponding to the second accommodating members and the positioning member, and a perpendicular stop twig; and the inserting poles at the frame body of the seat are then transversely inserted into the accommodating orifices of the second accommodating members, and the stop twig is pressed into the positioning orifice at the positioning member for prohibiting the inserting poles breaking off from the accommodating member while also achieving a rigid combination of the seat and the vehicle body by inserting and fastening the inserting poles into the accommodating members.

6. The vehicle body of electric vehicle according to claim 1, wherein a supporting segment is formed at the front rim of the second accommodating members, respectively; a stop twig is placed within a casing at the front rim of the frame body of the seat, and is also provided with a restoring spring for pushing the stop twig against the positioning member.

7. The vehicle body of electric vehicle according to claim 1, wherein at the bottom of the second accommodating members and the positioning member are provided with a vertical accommodating pole, respectively, and on the loading frame is disposed with accommodating pipes for accommodating corresponding vertical accommodating poles; the vertical accommodating poles and the accommodating pipes are further provided with a positioning orifice, respectively, for inserting twigs to insert and fasten therein, thus inserting and fastening the vertical accommodating poles into the accommodating pipes 15; and the relative positions of the accommodating poles and the accommodating pipes may be altered for changing the heights of the second accommodating members and the positioning member, thereby adjusting the height of the seat.
